(19) United States
(12) Patent Application Publication
(10) Pub. No.: US 2006/0080111 A1
(43) Pub. Date: Apr. 13, 2006

(54) Mobile electronic transaction system, device and method therefor

(76) Inventor: Thomas E Homeier-Beals, Livonia, MI (US)

Correspondence Address: Vague Protocol, 3510 E Pond Lane, Orion, MI, 48359, US

(21) Appl. No.: 10/528,919

(22) PCT Filed: Sep. 15, 2004
(86) PCT No.: PCT/US04/30281

§ 371 Date: Mar. 23, 2005

(30) Foreign Application Priority Data
Sep. 26, 2002 (US) 60413709

(51) Int. Cl. G06Q 99/00

(52) U.S. Cl. 705/1

(57) ABSTRACT

Disclosed herein as a system, device and method for conducting electronic transactions utilizing a wireless communications device adapted to receive a transaction program and data. The device comprises memory storage for storing a transaction program, a microprocessor and a display screen. The microprocessor executes instructions contained within the transaction program produces indicia representative of value, where value is selected from the group consisting an identifier of a purchased good, an identifier of a purchased service, a coupon, a discount, a prepaid transaction, an electronic negotiable instrument, a sum from a credit account, and a sum from a debit account. The indicia is readable by a scanner in communication with a merchant server, where the merchant server is adapted to access a provider server for storing and retrieving user account information.

### CROSS-REFERENCE TO RELATED APPLICATIONS

This application claims priority to U.S. Provisional Patent Application No. 60/03,121, filed on Sep. 15, 2003, the contents of which are incorporated herein by reference in its entirety.

### FIELD OF THE INVENTION

The present invention relates to a system, device and method for conducting electronic transactions, and more specifically, the present invention relates to electronic transactions utilizing a wireless communications device.

### BACKGROUND OF THE INVENTION

Electronic transactions conducted over the Internet, also known as electronic commerce or e-commerce, have enabled individuals to purchase products without leaving their homes. Typically, an e-commerce shopper will access a web site, scroll through goods, some of which may not be available, and then “check out”. The check out process involves providing payment information and arranging for shipping. Many e-commerce retailers charge a significant fee above the actual shipping cost for shipping. Additionally, the shopper has to wait for the goods they purchased to be delivered.

Payment is typically arranged by providing a credit card number online. A significant number of e-commerce shopper's have concerns about providing credit card information over the Internet. Although the liability for credit card holders is limited to $50 under the Fair Credit-Billing Act if an unauthorized charge is timely reported, the consumer ultimately pays for the fraud via interest rates and other fees.

New payment systems have been developed which respond in part to the security concerns about providing credit card information to third parties by facilitating the payment portion of a transaction. However, these new payment systems do not respond to concerns where an item is ordered and the e-commerce retailer does not deliver the selected item. The payment system will still charge the shopper's account as soon as the item is ordered. Months may pass before the situation is resolved, ultimately resulting in a dispute to the credit card company.

The proliferation of Internet retail services and advertising has enabled our society to become ever more paperless. E-commerce web sites employ many advertising methods to that draw Internet users to their web sites. However, coupons are distributed on paper rather than provided electronically.

Beyond the wired Internet, wireless e-commerce has taken the benefits of the Internet and added mobility. Therefore, it is advantageous to combine the benefits of wireless e-commerce with the mobility of wireless devices such as cellular phones and PDAs to provide immediate completion of a transaction.

One such system that combines wireless mobility and retail commerce is described in U.S. Pat. No. 6,577,861, “Electronic Shopping System Utilizing a Program Downloadable Wireless Telephone”, issued Jun. 10, 2003 to Ogasawara. The '861 patent discloses a wireless telephone connected with a bar code scanner as a substitute for a personal shopping terminal. The '861 patent is an advance in wireless e-commerce, however the system does have shortcomings. The '861 patent does not provide for selecting an item while the shopper is not in the store. Furthermore, the '861 system is limited to purchasing items that have an associated barcode. Lastly, the '861 system does not provide a means for making the transaction more paperless, nor is it applicable to services such as air travel, hotel or rental car accommodations.

Thus, it is desirable to provide a system, device and method for electronic transactions using a wireless device to select an item, service or discount remotely. Furthermore, there is a need to provide for paperless redemption of a coupon, a prepaid transaction, an electronic negotiable instrument, a sum from a credit account, and a sum from a debit account.

### SUMMARY OF THE INVENTION

A system for conducting electronic transactions, comprises a wireless communication device having memory storage, a display screen and a microprocessor, where the device is adapted to receive a transaction program and data. The transaction program is stored in the memory storage, the program contains instructions executable by the microprocessor to produce indicia representative of value on the display screen. The indicia representative of value is selected from the group consisting of an identifier of a purchased good, an identifier of a purchased service, a coupon, a discount, a prepaid transaction, an electronic negotiable instrument, a sum from a credit account, a sum from a debit account. A scanner is in communication with a merchant server for reading the indicia from the device. A provider server is accessible by the merchant server for storing and retrieving user account information.

The system may include a scanner that reads the indicia from the screen of the device. Furthermore, the indicia may be a two dimensional barcode. The wireless communication device may further comprise an antenna for communication with said provider server. The indicia may further be interpreted to be representative of a product or service.

A wireless communication device for conducting electronic transactions, where the device is adapted to receive a transaction program and data comprises a memory storage for storing a transaction program and a display screen for displaying information to a user. The device also comprises a microprocessor for executing instructions contained within the transaction program to produce indicia representative of value, where value is selected from the group consisting of an identifier of a purchased good, an identifier of a purchased service, a coupon, a discount, a prepaid transaction, an electronic negotiable instrument, a sum from a credit account, and a sum from a debit account, where the indicia is readable by a scanner in communication with a merchant server, where the merchant server is adapted to access a provider server for storing and retrieving user account information.

A scanner may read the indicia from the screen of the wireless communication device. The indicia may be a two dimensional barcode. The wireless communication device may further comprise an antenna for communication with said provider database. The indicia may also be representative of a product or service.

A method of conducting electronic transactions comprises the steps of providing a wireless communication device having memory storage, a display screen and a microprocessor, the device being adapted to receive a transaction program and data. Selecting a transaction and generating an indicia of value where value is selected from the group consisting of an identifier of a purchased good, an identifier of a purchased service, a coupon, a discount, a prepaid transaction, an electronic negotiable instrument, a sum from a credit account, and a sum from a debit account. Retrieving the indicia of value, providing the indicia of value to a merchant scanner and redeeming the indicia of value.

The indicia may be downloaded from a remote server. Alternatively, the indicia may be generated by the wireless communications device. The indicia may be a two dimensional bar code. The indicia of value may be redeemed by scanning the indicia from the screen of the wireless device. A further step may include entering a password before the step of retrieving the indicia of value.

Further objects, features and advantages of the present invention will become apparent to those skilled in the art from analysis of the following written description, the accompanying drawings and the appended claims.

### BRIEF DESCRIPTION OF THE DRAWINGS

FIG. 1 is a schematic illustration of the system for conducting electronic transactions according to the principles of the present invention.

FIG. 2 is a block diagram revealing a wireless communication device and provider server in further detail.

FIGS. 3a through 3c reveal sample screens displayed by a transaction program according to principles of the present invention.

FIGS. 4a through 4c reveal sample screens displayed by the transaction program for retrieving indicia according to principles of the present invention.

FIGS. 5a through 5d reveal sample screens displayed by the transaction program for selecting a transaction according to principles of the present invention.

### DESCRIPTION OF THE PREFERRED EMBODIMENT

A system provider enables a user to engage in electronic transactions by employing a wireless communications device in conjunction with proprietary software. Through encryption algorithms that make sensitive data unreadable in real time, the system provider becomes a secure payment system provider to consumers.

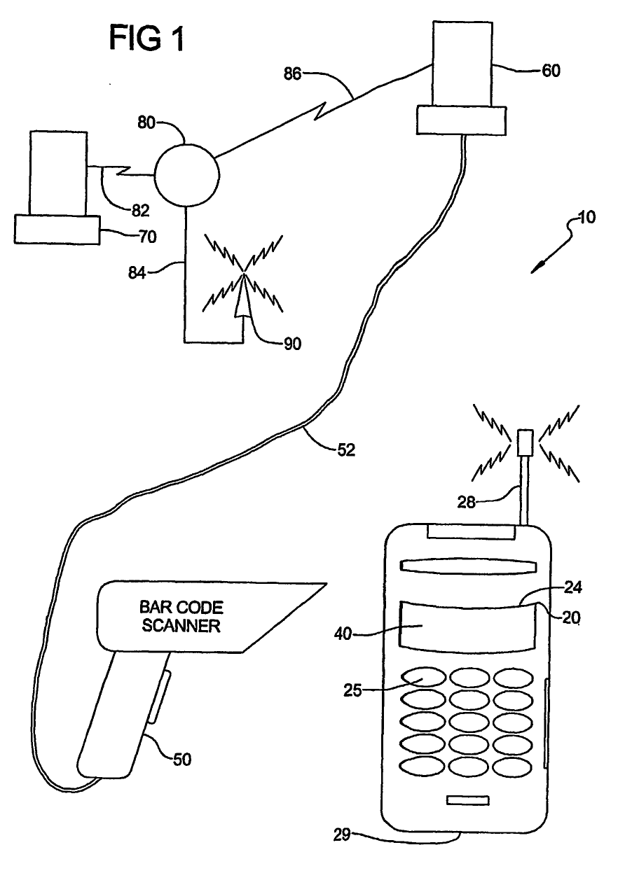

With initial reference to FIG. 1, a schematic illustration of a system 10 for conducting electronic transactions according to the principles of the present invention is shown. The system 10 for conducting electronic transactions comprises a wireless communications device 20 having a display screen 24 with indicia representing value, a good or service thereon. A scanner 50, which in the present embodiment is a bar code scanner is in communication with a merchant server 60 via a cable 52. The scanner 50 may be directly or indirectly coupled to the merchant server 60. For example the scanner 50 may first being communication with a point-of-sale system which then transmits data to the merchant server 60.

A provider server 70 is in communication with a network 80 via a line 82, such as the Internet or a wireless network. The network 80 is in communication with a cellular network 90 via a line 84. The provider server 70 is accessible by the merchant server 60 via a line 86, a PBX or any data transmission system known in the art.

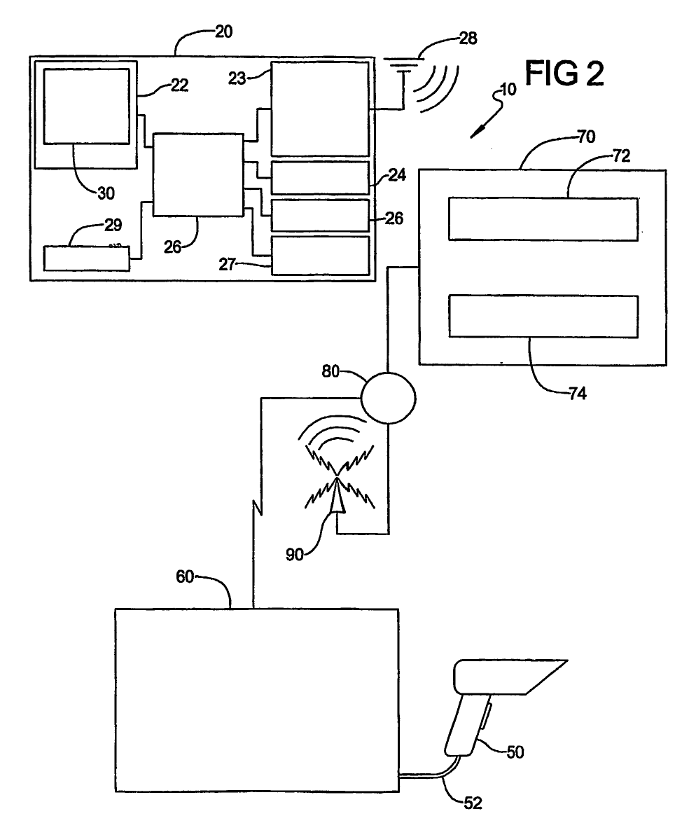

Referring now also to FIG. 2, is a block diagram revealing a wireless communication device and provider server in further detail is shown. Wireless device 20 comprises memory storage 22, an IO port 29, function electronics 23, a display screen 24, a keypad 25 and memory card reader 27 in communication with a microprocessor 26. An antenna 28 is in communication with function electronics 23 and enables device 20 to send and receive data. Alternatively, IO port 29 may enable device 20 to send and receive data, instead of, or in addition to antenna 28. It should be noted however, that any communication technology known the art including infrared, laser, or radio, such as Bluetooth®, may be employed to transmit and receive data. The scanner 50 may be a commercially available bar code scanner, such as a laser, laser diode, or charge coupled device. Additionally, scanner 50 may scan from any of the above mentioned communication technologies, including, but not limited to direct couple through an IO port, infrared, laser, or radio, such as from the antenna 28.

In the immediate embodiment, device 20 is a cellular telephone, however it should be apparent to those skilled in the art that any wireless device may be substituted for a cellular telephone including, but not limited to, a PDA (personal digital assistant), a handheld computer, or any device that comprises memory storage, a display screen and microprocessor.

The provider server 70 comprises a commerce program 72 and database 74. The provider database 74 may include information such as a username, password, bank account information, credit card information, selected coupons, a prepaid transaction, an electronic negotiable instrument, a sum from a credit account and a sum from a debit account. The commerce program 72 provides instructions to enable a user to conduct electronic transactions.

The merchant server 60 receives signals from the scanner 50 and communicates with the provider server 70. The merchant server 60 may also contain its own database for inventory and sales tracking.

A transaction program 30 is stored in the memory storage 22 of device 20. The program 30 may be downloaded by wireless communications, such as radio signals, laser or infrared, wire communications, such as through the IO port 29, or from external media, such as a memory card through card reader 27. The program 30 contains instructions executable by the microprocessor 26 to enable a user to browse and select goods, services and coupons. Furthermore, a user may employ the program 30 to locate a participating retailer or service provider.

A user selects a transaction by choosing a good, service, discount or coupon. Once the transaction is selected, the user pays for the good or service by using the transaction program 30 to contact the provider server 70 to cause the commerce program 72 to debit a credit account, debit a debit account, create an electronic negotiable instrument, create an identifier of a purchased good, or create an identifier of a purchased service. The database 74 records the actions taken by the commerce program 72. The database 74 may also record a prepaid transaction, a selected coupon, a discount, as well as any other pertinent user information, preferences or information indicative of purchasing habits.

In one embodiment, the transaction program 30 stored on device 20 will create an indicia 40 representative of value, where value is selected from an identifier of a purchased good, an identifier of a purchased service, a coupon, a discount, a prepaid transaction, an electronic negotiable instrument, a sum from a credit account, and a sum from a debit account. The indicia may also be representative of a product or service. Alternatively, the commerce program 72 on the provider server 70 may create the indicia 40, which is subsequently downloaded by the device 20.

When a user is ready to complete a transaction at a participating retailer, the user will retrieve the indicia 40 of value by providing the indicia 40 of value to a merchant scanner 50 and redeem the indicia 40. In the preferred embodiment, the user will command the transaction program 30 to display indicia 40 representative of value on the display screen 24 of device 20.

An indicia 40 representative of value will appear on the screen 24. In the preferred embodiment, the message is a two dimensional bar code. Experiment has shown that in the best mode, the user of the present invention will cause the backlight of the screen 24 to illuminate to provide the best image for scanning by the scanner 50. A scanner 50 will scan the indicia 40 from the wireless device 20. In the preferred embodiment, the scanner 50 scans indicia 40 from the screen 24. However, it is contemplated to be within the scope of the present invention that the indicia 40 may be scanned from the wireless device 20 by any means known in the art, including communication devices based on infrared, laser, or radio frequency or electrical signals. For example, an infrared port (not shown) disposed in device 20 may communicate the indicia 40 to scanner 50.

In one mode of operation the wireless communication device 20 is in communication with a device adapted to communicate with a network, such as a personal computer connected to the Internet. Any means known in the art for communication between a wireless device and personal computer may be employed, including, but not limited to, a cradle or cable. The data necessary to generate indicia 40 representative of value or the indicia 40 may be downloaded from the provider server 70 to the wireless device 20 through IO port 29 coupled to a personal computer. Furthermore, the browsing and selection of an item may be completed through a personal computer and then the necessary data to generate indicia or indicia may be downloaded to the device 20. Therefore, the device 20 does not necessarily need to be capable of data transmission through an antenna 28 in order to be operable within the system 10 of the present invention.

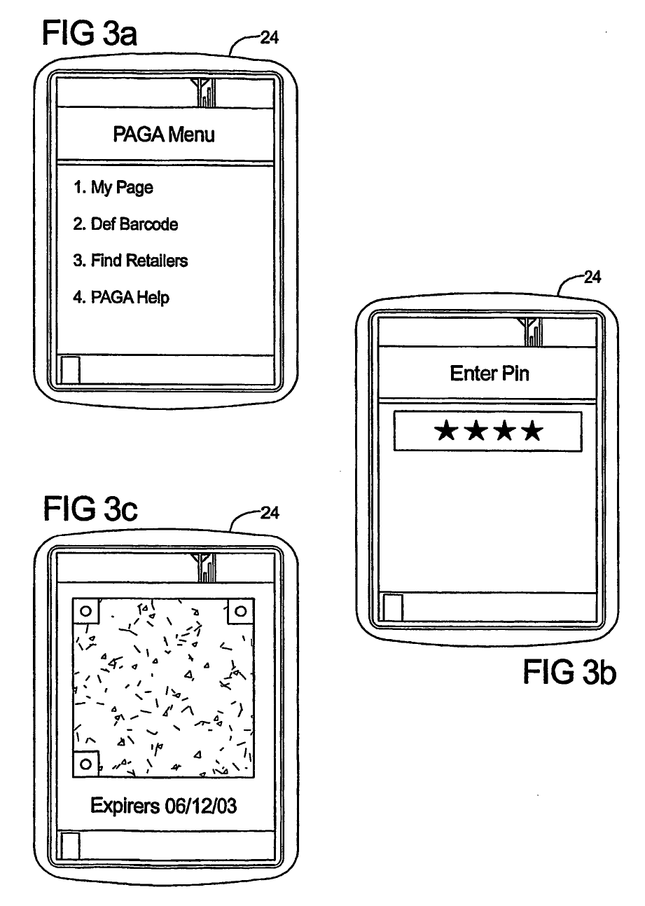

Referring now to FIGS. 3a through 3c, sample screens 24 displayed by a transaction program 30 reveal an example of using the present invention as a payment system. Specifically, FIG. 3a reveals an exemplary menu screen for making a payment to a merchant. The user will select the “Get Barcode” option to retrieve a stored barcode. The program 30 will prompt the user to enter a password, as shown in FIG. 3b. The user will then enter a password, more specifically a user PIN, to access the indicia 40, which in the present example is a 2-dimensional barcode. The indicia 40 expires once it has been redeemed, as shown in FIG. 3c.

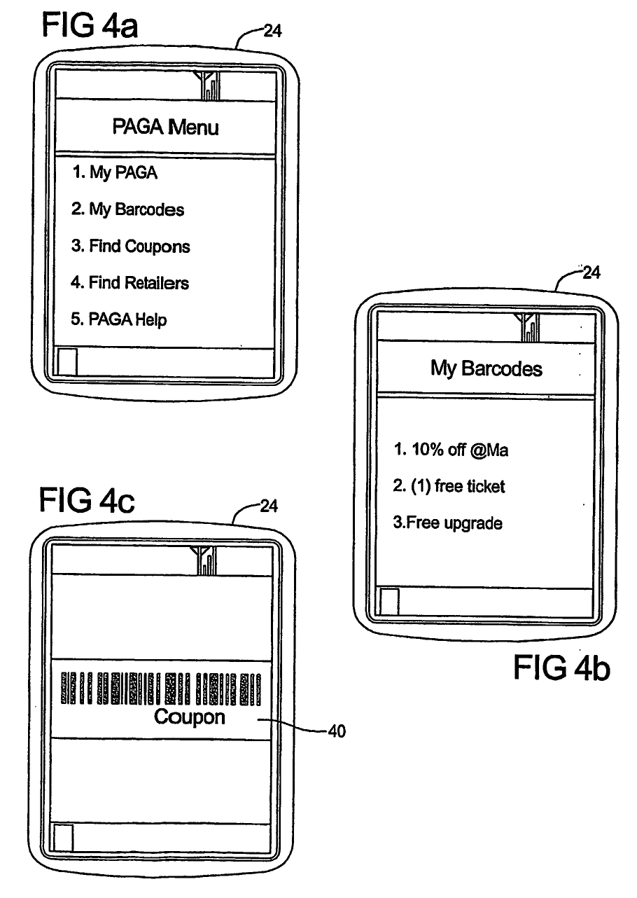

Referring now to FIGS. 4a through 4c, sample screens 24 displayed by a transaction program 30 reveal an example of using the present invention as to redeem coupons. Specifically, FIG. 4a reveals an exemplary menu screen for retrieving a coupon to present to a merchant. The user will select the “Find Coupons” option to retrieve a stored indicia 40 of a coupon, which in this example is a barcode. The program 30 will display a list of available coupons, as shown in FIG. 4b. The user will then select a coupon to display. The program 30 will then display a coupon on the screen 24 for scanning as shown in FIG. 4c.

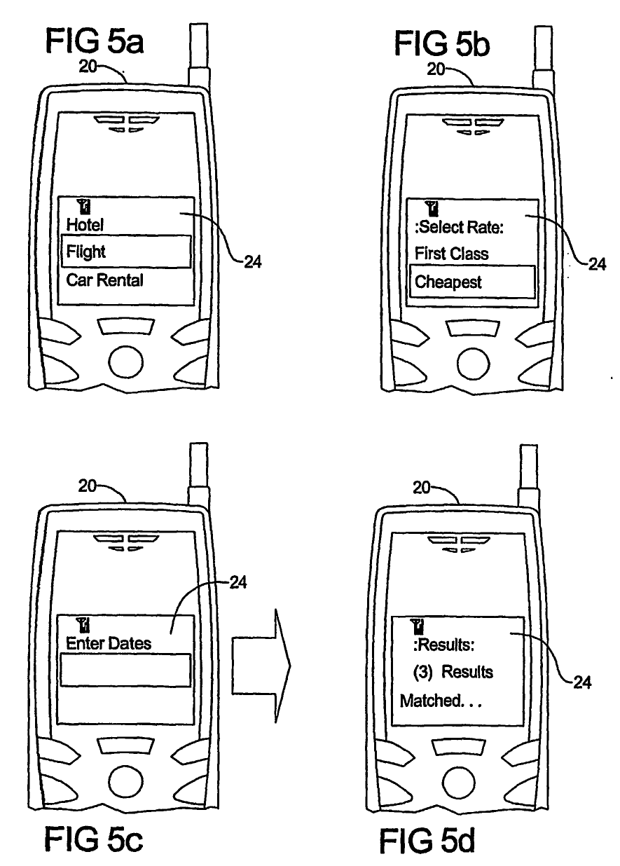

Referring now to FIGS. 5a through 5d, sample screens 24 displayed by a transaction program 30 on device 20, which in the present example is a cellular phone 20, reveal an example of using the present invention to select a transaction. Specifically, FIG. 5a reveals an exemplary menu screen for selecting among a number of services available to a user of the system 10 of the present invention. The user will select the “Flights” option to brows available flights. The program 30 will display a list of available search criteria, as shown in FIG. 5b. The user will then select criteria, which in the present example is “Cheapest”. The program 30 will then display a query menu for dates on the screen 24, as shown in FIG. 5c. The program 30 will then display matches that have been found on the screen 24, as shown in FIG. 5d. The user may now select a flight and pay for the service. Later at an airport terminal, the user will prompt a scanner 50 to scan the device 20 to print a ticket or boarding pass.

The foregoing discussion discloses and describes the preferred structure and control system for the present invention. However, one skilled in the art will readily recognize from such discussion, and from the accompanying drawings and claims, that various changes, modifications and variations can be made therein without departing from the true spirit and fair scope of the invention as defined in the following claims.

What is claimed is:

1. A system for conducting electronic transactions, comprising:
a wireless communication device having memory storage, a display screen and a microprocessor, said device adapted to receive a transaction program and data;
a transaction program stored in said memory storage, said program containing instructions executable by said microprocessor to produce indicia on said display screen representative of value, where value is selected from the group consisting of an identifier of a purchased good, an identifier of a purchased service, a coupon, a discount, a prepaid transaction, an electronic negotiable instrument, a sum from a credit account, and a sum from a debit account;
a scanner in communication with a merchant server for reading said indicia from said device; and
a provider server accessible by the merchant server for storing and retrieving user account information.

2. The system of claim 1, wherein said scanner reads said indicia from said screen.

3. The system of claim 2, wherein said indicia is a two dimensional barcode.

4. The system of claim 1, wherein said wireless communication device flirter comprises an antenna for communication with said provider server.

5. The system of claim 1, wherein said indicia is also representative of a product or service.

6. A wireless communication device for conducting electronic transactions, said device adapted to receive a transaction program and data, comprising:
memory storage for storing a transaction program;
a display screen; and
a microprocessor for executing instructions contained within said transaction program to produce indicia representative of value, where value is selected from the group consisting an identifier of a purchased good, an identifier of a purchased service, a coupon, a discount, a prepaid transaction, an electronic negotiable instrument, a sum from a credit account, and a sum from a debit account, said indicia readable by a scanner in communication with a merchant server, where the merchant server is adapted to access a provider server for storing and retrieving user account information.

7. The wireless communication device of claim 6, wherein said scanner reads said indicia from said screen.

8. The wireless communication device of claim 7, wherein said indicia is a two dimensional barcode.

9. The wireless communication device of claim 6, wherein said wireless communication device further comprises an antenna for communication with said provider database.

10. The wireless communication device of claim 6, wherein said indicia is also representative of a product or service.

11. A method of conducting electronic transactions, said method comprising:
providing a wireless communication device having memory storage, a display screen and a microprocessor, the device being adapted to receive a transaction program and data;
selecting a transaction;
generating an indicia of value where value is selected from the group consisting of an identifier of a purchased good, an identifier of a purchased service, a coupon, a discount, a prepaid transaction, an electronic negotiable instrument, a sum from a credit account, and a sum from a debit account;
retrieving the indicia of value;
providing the indicia of value to a merchant scanner; and
redeeming the indicia of value.

12. The method of conducting electronic transactions as set forth in claim 11, wherein the indicia is downloaded from the provider server.

13. The method of conducting electronic transactions as set forth in claim 11, wherein the indicia is generated by the wireless communications device.

14. The method of conducting electronic transactions as set forth in claim 11, wherein the indicia is a two dimensional bar code.

15. The method of conducting electronic transactions as set forth in claim 11, wherein where the indicia of value is redeemed by scanning the indicia from the screen of the wireless device.

16. The method of conducting electronic transactions as set forth in claim 11, further comprising the step of entering a password before the step of retrieving the indicia of value.
